(19) United States
(12) Patent Application Publication
(10) Pub. No.: US 2004/0190039 A1
(43) Pub. Date: Sep. 30, 2004

(54) Auto print job cancellation

(76) Inventors: D. Travis Lay, Horseshoe Bend, ID (US); Curtis Reese, Boise, ID (US); Pat Dowdell, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/400,971

(22) Filed: Mar. 27, 2003

(51) Int. Cl. G06F 15/00

(52) U.S. Cl. 358/1.14; 358/1.13

(57) ABSTRACT

A method and apparatus for canceling a corrupted print job in an imaging environment is described. The method terminates a corrupted print job by monitoring the image data of the print job for the presence of at least one characteristic indicative of a corrupted print job. When the characteristic is detected, the remaining print job is cancelled thereby preserving resources. An apparatus for monitoring the image data including processes that search for characteristics within the print job that are indicative of corrupted data is also disclosed. The apparatus also initiates a cancellation of the remaining portion of the print job. An imaging device incorporating the method and monitor apparatus is also disclosed.

### BACKGROUND OF THE INVENTION

1. Field of the Invention

The present invention relates to operation and control of an imaging device. More specifically, the present invention relates to automatic cancellation of a print job after errors have occurred.

2. State of the Art

Print jobs sent from a computer to a printer depend upon reliable communication between the computer and printer. When printers receive corrupted print jobs, the printed output may be a number of blank or only partially printed pages. One source of this problem may occur when communication is disrupted or corrupted between a computer and a connected printer. When processing the resultant corrupted print job, varieties of print data become misinterpreted by the printer. For example, if corrupt print job data causes the printer to exit an image processing mode, the printer may begin printing the residual image data as text, resulting in pages covered with no data or nominal data, generally in the form of stray letters and symbols, typically the ASCII code for the data. Once the corrupted print job begins, the printer typically continues to print blank or erroneously-imaged pages until it exhausts, and hence wastes its paper supply.

While corrupted print jobs may be cancelled, they must first be detected. Detection has required user observation while print job cancellation has required user intervention. User detection and intervention may not be practically observed and executed until well into the paper wasting process. Therefore, there is a need for an automated detection and cancellation process for corrupted print jobs.

### BRIEF SUMMARY OF THE INVENTION

A method and apparatus for canceling a corrupted print job is provided. In one embodiment of the present invention, a method is provided for terminating a corrupted print job by monitoring the image data of the print job for the presence of at least one characteristic indicative of a corrupted print job. When the characteristic is detected, the remaining print job is cancelled thereby preserving resources.

In another embodiment of the present invention, an apparatus for canceling a print job is provided. The apparatus includes an imaging process for generating an image output according to the image data of the print job and further includes a print job cancellation monitor configured to monitor the image data of the print job for a characteristic that is indicative of a corrupted print job. The monitor initiates a cancellation of the remaining portion of the print job when corrupted image data is detected. In yet another embodiment, an imaging device, such as a printer, is also provided. The imaging device is configured for coupling to a print data source, such as a computer, by way of an imaging module. The imaging device further includes an imaging process configured to generate image output and a print job cancellation monitor configured to monitor the print job for a characteristic that is indicative of a corrupted print job.

### BRIEF DESCRIPTION OF THE SEVERAL VIEWS OF THE DRAWINGS

In the drawings, which illustrate what is currently considered to be the best mode for carrying out the invention:

FIG. 1 is a block diagram of a system for detecting and canceling a corrupted print job, in accordance with an embodiment of the present invention;

FIG. 2 is a block diagram of an auto print job cancellation monitor, in accordance with an embodiment of the present invention;

FIG. 3 is a flow chart illustrating an excess adjacent blank page print job cancellation process, in accordance with an embodiment of the present invention;

FIG. 4 is a flow chart of an excess adjacent sparse-data page print job cancellation process, in accordance with an embodiment of the invention;

FIG. 5 is a flow chart of an excess sparsely-finish page print job cancellation process, in accordance with an embodiment of the present invention;

FIG. 6 is a flow chart of a nonprintable area print job cancellation process, in accordance with an embodiment of the present invention;

FIG. 7 is a user-defined print job cancellation process, in accordance with an embodiment of the present invention;

FIG. 8 is a block diagram of a networked status notification system, in accordance with an embodiment of the present invention.

### DETAILED DESCRIPTION OF THE INVENTION

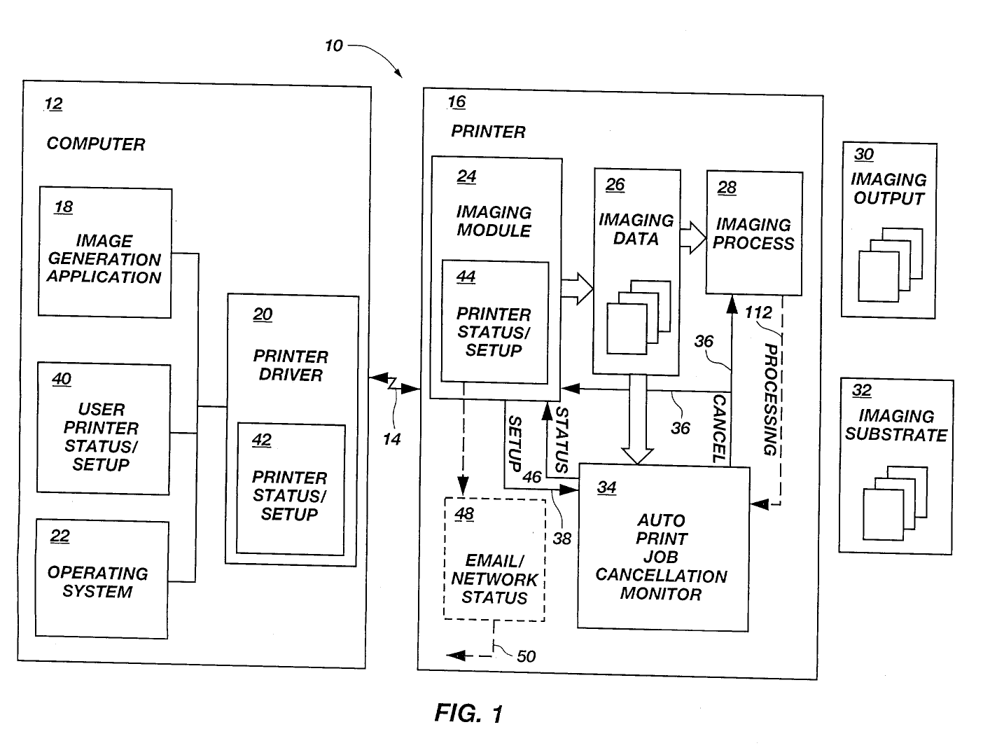

The present invention includes a method and apparatus for identifying a corrupted print job through an automatic means and performing a cancellation of the corrupted print job in an automated manner. While the present figures illustrate an independent computing host separate from an imaging device, the present invention contemplates the integration of such an image-generating host with an image printing device. The present invention provides a method and system for automatically canceling a printing process on a printing or imaging device when the printing process or job has become corrupted or otherwise unmanageable. FIG. 1 illustrates an environment within which the present invention may be practiced, namely, a system 10 including a hosting device, such as a computer 12, an imaging device, such as a printer 16, and coupling interface 14, which may include a wired or wireless physical interface.

Computer 12 may be a typical personal computer or may assume, other instruction-executable platforms, known by those of ordinary skill in the art. Computer 12, of FIG. 1, includes an operating system 22 which performs typical management of other software applications in conjunction with associated hardware (not shown) of computer 12. Computer 12 further includes software applications, illustrated as image generation application 18, configured to generate images for rendering by printer 16. Typical image generation applications 18 include word processing, spreadsheet, drawing and other imaging applications.

To facilitate compatible data transfer between image generation application 18 and printer 16, computer 12 further includes a printer driver 20 configured according to the operational specifics of printer 16. Such operational specifics are appreciated by those of ordinary skill in the art and are not further discussed herein. Printer driver 20 generates print data (not shown) for traversal across interface 14 and for consumption by printer 16. Interface 14 may further facilitate direct coupling between computer 12 and printer 16 (e.g., serial or parallel standard interfaces, etc.) or may further include indirect coupling via a server or other networking means (e.g., Local Area Network (LAN) or Wide Area Network (WAN), etc.). Regardless of the connectivity mode, interface 14 facilitates communication between computer 12 and printer 16. Printer 16 facilitates imaging or other rendering of information received from computer 12 via interface 14. Printer 16 is further configured to receive a service request, generally termed a “print job,” from computer 12.

Printer 16 includes an imaging module 24 configured to receive print data (not shown) via interface 14 from printer driver 20 of computer 12. In a typical printing process, imaging module 24 generates image data 26 from the print data received from computer 12. Printer 16 further includes an imaging process 28 for receiving image data 26 and generating image output (e.g. printed pages) 30, in accordance with the intended purpose of printer 16.

While the printing process may generally operate error free, it is not uncommon for print data to become corrupted which, in turn, causes image data 26 to instruct imaging process 28 to generate image output 30 in a manner not originally specified by image generation application 18. As described, practical failure modes include the excessive generation of image output 30 and, furthermore, failure modes frequently result in the application of sparse or nominal images to an imaging substrate 32.

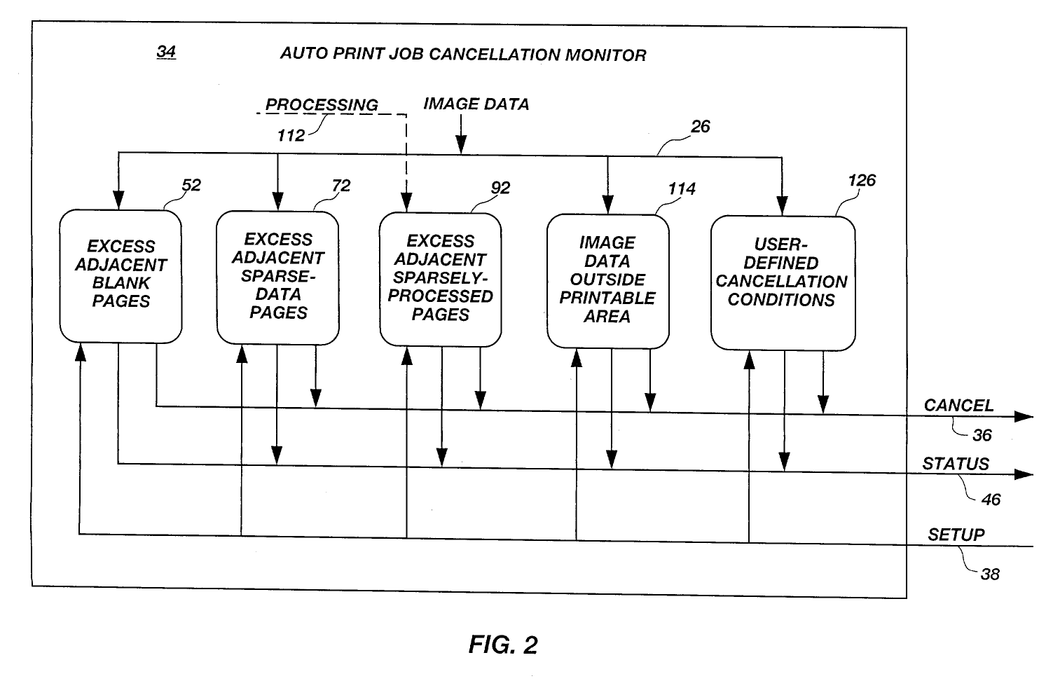

In an embodiment of the present invention, printer 16 further includes an auto print job cancellation monitor 34. Generally, auto print job cancellation monitor 34 scrutinizes image data 26 for specific data characteristics of corrupted print data. Auto print job cancellation monitor 34 may be implemented as a combination of an independent processing mechanism executing according to software instructions, or may utilize other execution resources resident within printer 16. The specific execution processes of auto print job cancellation monitor 34 are further described below with reference to FIGS. 2-7.

As illustrated in FIG. 1, auto print job cancellation monitor 34, in response to the detection of corrupted image data 26, generates a cancel control signal 36 causing image process 28 to suspend any further generation of image output 30. Alternatively, the cancel control signal 36 may be directed to imaging module 24 requesting the suspension of any further image data 26 from being passed and therefore processed by imaging process 28.

The specific print job cancellation processes, further described with reference to FIGS. 2-7, allow user input, illustrated in FIG. 1 as setup signal 38. Setup signal 38 originates from an input environment on computer 12, illustrated as user printer status/setup 40. In one embodiment, setup information is relayed from user printer status setup 40 to printer 16 via printer status setup processes 42 and a respective printer status setup process 44. While various setup-relaying mechanisms between computer 12 and printer 16 are contemplated, one known mechanism includes the utilization of a Printer Job Language (PJL) and may further include other networking implementations, an example of which is the Printer Management Language (PML) available from Hewlett Packard Corp. of Palo Alto, Calif.

Another embodiment of the present invention further contemplates a status notification process wherein the cancellation or the assertion of cancel signal 36, causes the cancellation of a print job, further resulting in the notification of the print job cancellation to an interested party. By way of example, and not limitation, auto print job cancellation monitor 34, upon the issuance of cancel signal 36, further issues a status signal 46 which may be further relayed to an interested party by way of the printer status setup process 44 of printer 16 and the corresponding printer status setup process 42 of computer 12. While the present status notification process is illustrated as utilizing an existing interface 14 between computer 12 and printer 16, an alternative embodiment further contemplates utilization of a collateral or additional messaging pathway, an example of which is illustrated as email network notification process 48. In email network notification process 48, the status signal 46 is intercepted or directly routed to email network notification process 48 which utilizes a network interface 50 for dispatching the print job cancellation status for reception by computer 12 through typical email or network delivery processes (not shown) appreciated by those of ordinary skill in the art and not further described herein.

FIG. 2 is a functional block diagram illustrating a plurality of various print job cancellation processes that may be included within auto print job cancellation monitor 34. It should be appreciated that the specific print job cancellation processes illustrated are exemplary and not inclusive of all possible conditions under which it may be desirable to cancel a specific print job. Furthermore, while the specific illustration of auto print job cancellation monitor 34, as illustrated in FIG. 2, depicts a plurality of print job cancellation processes, utilization of a single print job cancellation process (i.e., a single set of desirable print job cancellation conditions) is also contemplated as being within the scope of the present invention. Furthermore, the cumulative illustration of a plurality of print job cancellation processes in FIG. 2 is for illustrative convenience.

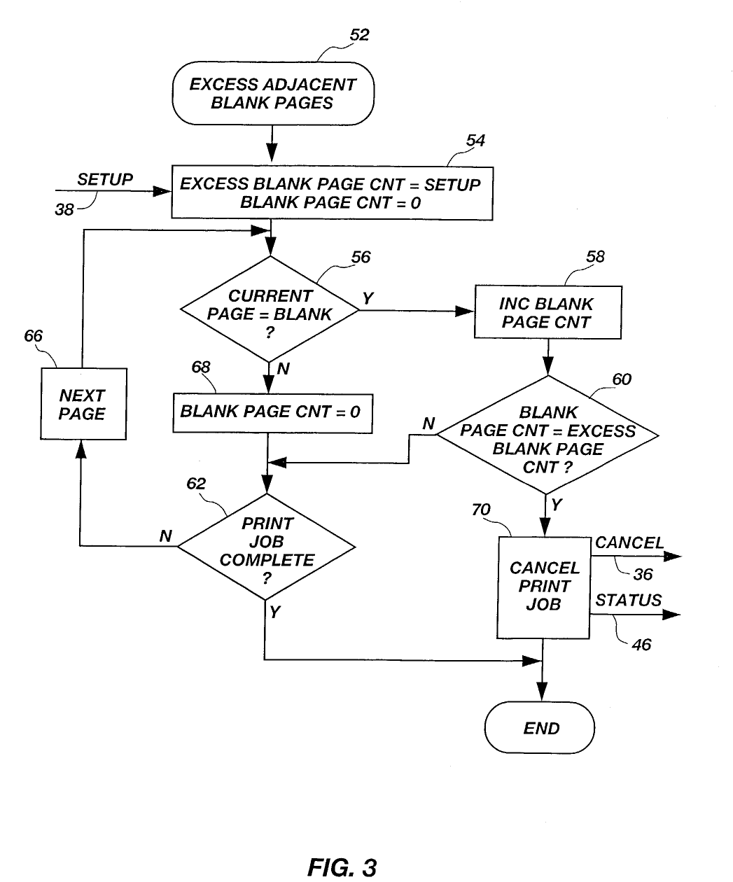

Referring to FIG. 2, auto print job cancellation monitor 34 receives image data 26 for analysis by one or more print job cancellation processes. FIG. 2 illustrates setup signal 38 being provided as an input to a respective print job cancellation process, however, it is further contemplated within the scope of the present invention that print job cancellation processes may be preconfigured with a predefined “set up signal” that defines the unacceptable range of image data 26. Furthermore, status signal 46 is illustrated as being output by a print job cancellation process in the form of a status signal to be consumed or observed by an interested party, as previously described. The present invention further contemplates the absence of status notification in response to a print job cancellation. Each of the illustrated print job cancellation processes will be described by way of corresponding flow diagrams of FIGS. 3-7.

One print job cancellation process is illustrated as an excess adjacent blank pages process 52 which generally monitors image data 26 for the detection of a quantity of adjacent blank pages that exceeds a specified or predetermined count. Referring to FIG. 3, process 52 initializes 54 the excess blank page count according to a setup value or signal 38 or alternatively according to a predefined value and further resets the current blank page count to zero. Process 52 then queries 56 the current page of image data 26 to determine if the page is blank. If query 56 determines that the page is in fact blank, then the blank page count increments 58 and the blank page count is queried 60 to determine if the blank page count is equivalent to the excess blank page count previously defined. When the excess blank page count has not been reached, process 52 evaluates the status of the completion of the print job 62 and, when the print job is not complete, process 52 retrieves 66 the next page and processing returns to query 56. When a blank page is not detected in query 56, the blank page count is reset 68 and processing continues. When query 60 determines that the blank page count is equal to the excess blank page count, then the print job is cancelled 70 by cancel signal 36 and status signal 46 is generated, in accordance with an embodiment of the present invention.

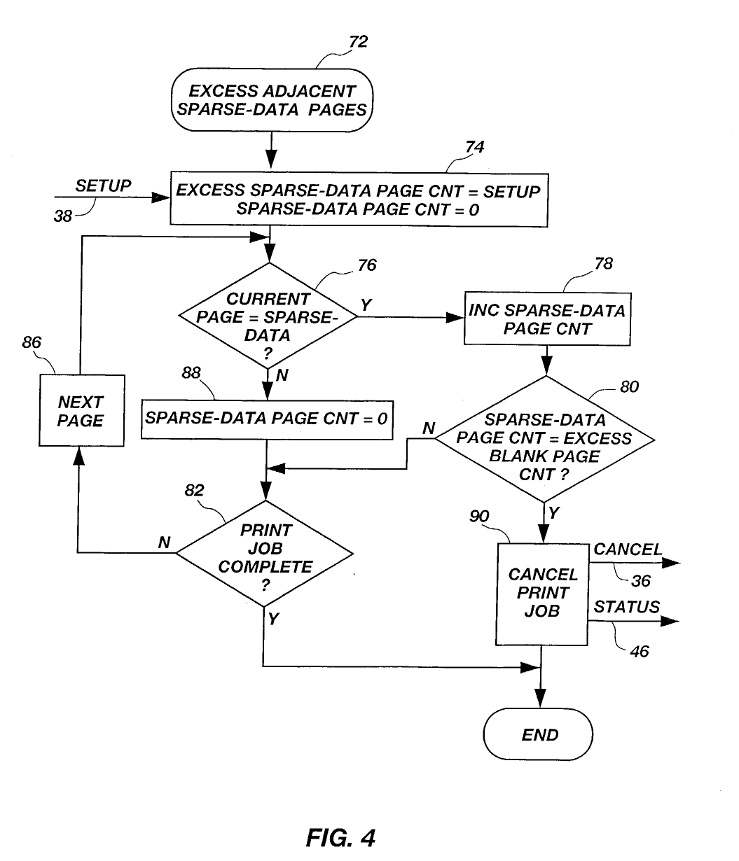

FIG. 2, and more particularly FIG. 4, illustrates another print job cancellation process, namely excess adjacent sparse-data pages process 72 which generally monitors image data 26 for the presence of sparsely or nominally data-populated adjacent pages. As appreciated by one of ordinary skill in the art, corrupted image data, not infrequently, becomes corrupted in such a manner that results in a data pattern resulting in consecutive sparsely populated pages. Therefore, process 72 evaluates image data 26 to determine if an excess amount of adjacent pages are in fact of the sparsely populated variety.

Referring to FIG. 4, process 72 initializes 74 the excess sparse-data page count according to a setup value or signal 38 or alternatively according to a predefined value and further resets the current sparse-data page count to zero. Process 72 then queries 76 the current page of image data 26 to determine if the page is sparsely populated. If query 76 determines that the page is in fact sparsely populated, then the sparse-data page count increments 78 and the sparse-data page count is queried 80 to determine if the sparse-data page count is equivalent to the excess sparse-data page count previously defined.

When the excess sparse-data page count has not been reached, process 72 evaluates the status of the completion of the print job 82 and, when the print job is not complete, process 72 retrieves 86 the next page and processing returns to query 76. When a sparse-data page is not detected in query 76, the sparse-data page count is reset 88 and processing continues. When query 80 determines that the sparse-data page count is equal to the excess sparse-data page count, then the print job is cancelled 90 by cancel signal 36 and status signal 46 is generated, in accordance with an embodiment of the present invention.

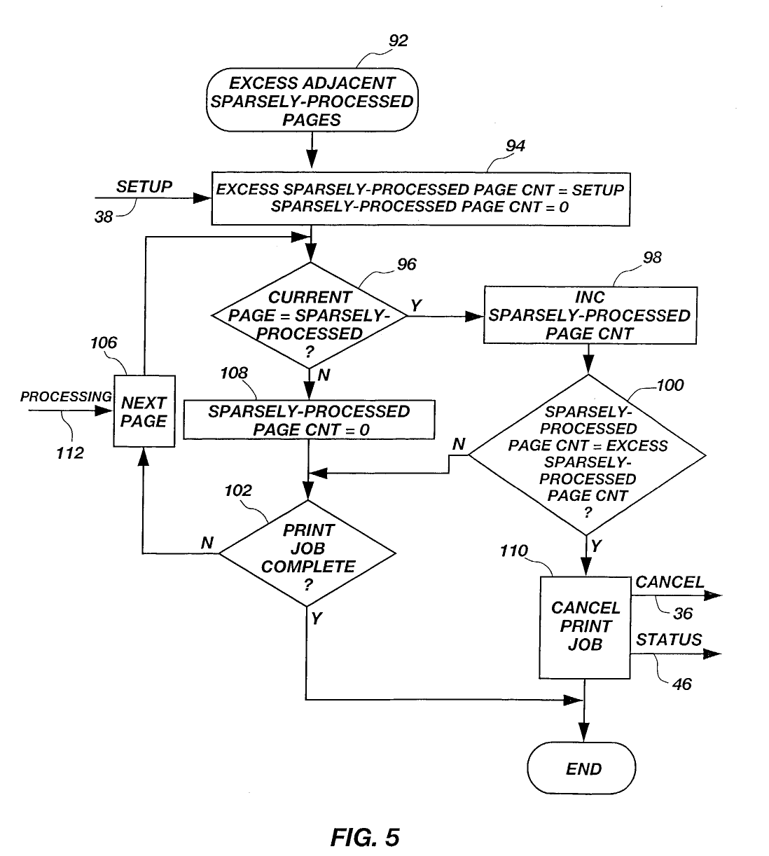

FIG. 2, and more particularly FIG. 5, illustrates another print job cancellation process, in accordance with another embodiment of the present invention. In FIG. 5, an excess adjacent sparsely-processed pages process 92 monitors a processing signal 112 (FIG. 1) as received from the imaging process 28 (FIG. 1) to determine if a nominally unacceptable amount of resources (e.g., printing toner, etc.) is placed on a specific sheet of imaging substrate 32 (FIG. 1). Consecutive measurements of nominal amounts of processing resources being applied to or performed on an individual sheet of imaging substrate 32 is indicative of corrupted print data. Therefore, process 92 evaluates processing signal 112 to determine if a nominal amount of finishing processes are being performed on an excessive amount of adjacent pages.

Referring to FIG. 5, process 92 initializes 94 the excess sparsely-processed page count according to a setup value or signal 38 or alternatively according to a predefined value and further resets the current sparsely-processed page count to zero. Process 92 then queries 96 the processing signal as it relates to a current page of image output 30 to determine if the page is sparsely processed. If query 96 determines that the page is in fact sparsely processed, then the sparsely-processed page count increments 98 and the sparsely-processed page count is queried 100 to determine if the sparsely-processed page count is equivalent to the excess sparsely-processed page count previously defined.

When the excess sparsely-processed page count has not been reached, process 92 evaluates the status of the completion of the print job 102 and, when the print job is not complete, process 92 retrieves 106 the next processing signal 112 as it relates to the next page and processing returns to query 96. When a sparsely-processed page is not detected in query 96, the sparsely-processed page count is reset 108 and processing continues. When query 100 determines that the sparsely-processed page count is equal to the excess sparsely-processed page count, then the print job is cancelled 110 by cancel signal 36 and status signal 46 is generated, in accordance with an embodiment of the present invention.

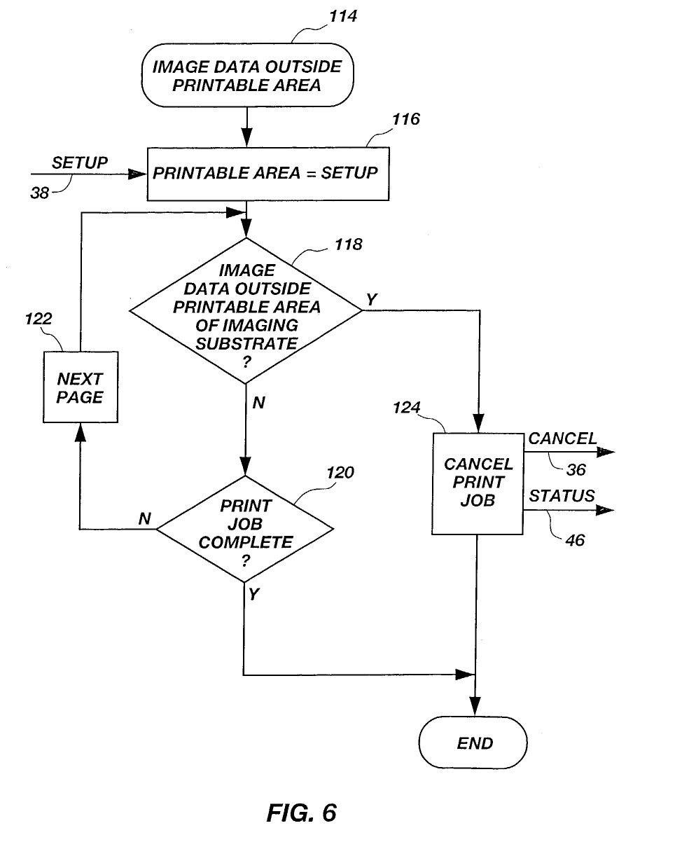

FIG. 2, and more particularly FIG. 6, illustrates another print job cancellation process, in accordance with another embodiment of the present invention. In FIG. 6, image data designated outside the printable area process 114 generally monitors image data 26 for the presence of image data 26 specifying printing outside of the printable area of imaging substrate 32. As appreciated by one of ordinary skill in the art, corrupted image data, not infrequently, becomes corrupted in such a manner that results in a request for printing outside the printable area as defined by the specific imaging substrate. Therefore, process 112 evaluates image data 26 to determine if image data 26 specifies printing outside of the allowable printable area.

Referring to FIG. 6, process 114 initializes 116 the printable area according to a setup value or signal 38 or alternatively according to a predefined value. Process 114 then queries 118 the current page of image data 26 to determine if imaging is requested outside of the printable area. If query 118 determines that the imaging data is not designated outside the printable area, then process 114 evaluates the status of the completion of the print job 120 and, when the print job is not complete, process 114 retrieves 122 the next page and processing returns to query 118. When query 118 determines that imaging is requested outside of the printable area, then the print job is cancelled 124 by cancel signal 36 and status signal 46 is generated, in accordance with an embodiment of the present invention.

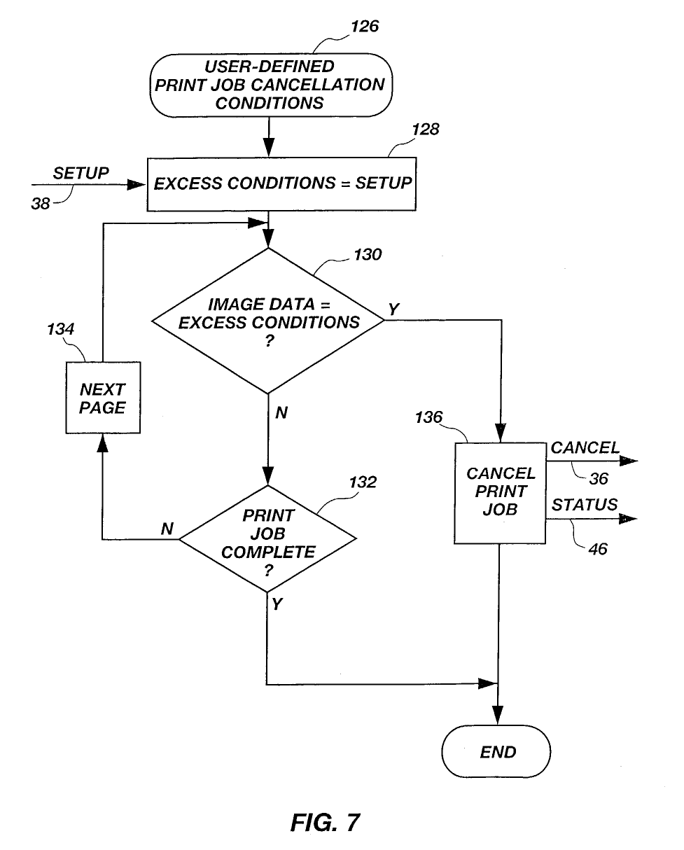

FIG. 2, and more particularly FIG. 7, illustrates yet another print job cancellation process, in accordance with another embodiment of the present invention. In FIG. 7, user-defined print job cancellation conditions process 126 generally monitors image data 26 for the presence of a user-defined excess condition. In specific dedicated imaging environments, imaging conditions may be identified that result in undesirable waste. The present embodiment allows a user to specify conditions under which it would be desirable to cancel print jobs.

Referring to FIG. 7, process 126 initializes 128 the excess conditions according to a user-defined value or signal 38. Process 126 then queries 130 the current page of image data 26 to determine if the user-defined cancellation condition exists. If query 130 determines that the imaging data is not consistent with the user-defined cancellation conditions, then process 126 evaluates the status of the completion of the print job 132 and, when the print job is not complete, process 126 retrieves 134 the next page and processing returns to query 130. When query 130 determines that the image data violates the user-defined print job cancellation conditions, then the print job is cancelled 136 by cancel signal 36 and status signal 46 is generated, in accordance with an embodiment of the present invention.

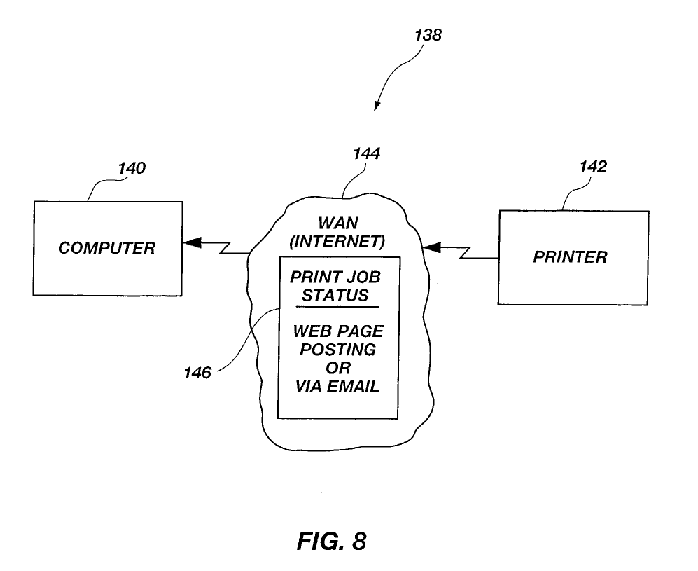

FIG. 8 is a block diagram of a networked status notification system, in accordance with an embodiment of the present invention. A system 138 includes a computer 140 and a printer 142 which are generally configured according to the specifics previously described. The system 138 of the present embodiment further includes a network 144 which facilitates the posting of a print job status 146 for accessing by computer 140. In one embodiment, network 144 includes an area network (e.g., Local Area Network (LAN), Wide Area Network (WAN), Internet, etc.) for accommodating the posting of print job status 146, a specific example of which includes the posting of print job status 146 to a web page that is accessible to computer 140. A further embodiment contemplates the delivery of print job status 146 via electronic mail.

Although the foregoing description contains many specifics, these should not be construed as limiting the scope of the present invention, but merely as providing illustrations of some embodiments of the invention. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions, and modificatons to the invention, as disclosed herein, which fall within the meaning and scope of the claims are to be embraced thereby.

What is claimed is:

1. A method for terminating a corrupted print job, comprising:
monitoring image data of a print job received at an imaging device for at least one corrupt print job characteristic; and
canceling a remainder of said print job in said imaging device when said at least one corrupt print job characteristic is detected.

2. The method of claim 1, wherein said monitoring comprises:
defining said at least one print job characteristic from user-setup information; and
comparing at least a portion of said image data with said at least one print job characteristic.

3. The method of claim 1, wherein said at least one corrupt print job characteristic includes excessive adjacent blank pages.

4. The method of claim 1, wherein said at least one corrupt print job characteristic includes excessive adjacent sparsely data-populated pages.

5. The method of claim 1, wherein said at least one corrupt print job characteristic includes excessive adjacent sparsely-image processed pages.

6. The method of claim 1, wherein said at least one corrupt print job characteristic includes said image data defined for imaging outside of a printable area.

7. The method of claim 1, wherein said at least one corrupt print job characteristic includes a user-defined characteristic.

8. The method of claim 1, wherein said canceling further comprises generating a print job cancellation status.

9. The method of claim 8, wherein generating a print job cancellation status further comprises sending said print job cancellation status to an originator of said image data.

10. The method of claim 9, wherein sending comprises sending said print job cancellation status via email.

11. An apparatus for canceling a print job, comprising:
an imaging process configured to generate image output as defined by said image data of a print job; and
a print job cancellation monitor configured to monitor said image data of said print job for at least one corrupt print job characteristic and further configured to cancel a remainder of said print job when said at least one corrupt print job characteristic is detected.

12. The apparatus of claim 11, wherein said print job cancellation monitor includes a print job cancellation process configured to monitor said image data for excessive blank pages defined as said at least one corrupt print job characteristic.

13. The apparatus of claim 11, wherein said print job cancellation monitor includes a print job cancellation process configured to monitor said image data for excessive adjacent sparsely data-populated pages defined as said at least one corrupt print job characteristic.

14. The apparatus of claim 11, wherein said print job cancellation monitor includes a print job cancellation process configured to monitor said image data for excessive adjacent sparsely-image processed pages defined as said at least one corrupt print job characteristic.

15. The apparatus of claim 11, wherein said print job cancellation monitor includes a print job cancellation process configured to monitor said image data for defined imaging outside of a printable area defined as said at least one corrupt print job characteristic.

16. The apparatus of claim 11, wherein said print job cancellation monitor includes a print job cancellation process configured to monitor said image data for a user-defined characteristic defined as said at least one corrupt print job characteristic.

17. The apparatus of claim 11, wherein said print job cancellation monitor is further configured to generate a print job cancellation status.

18. An imaging device, comprising:
an imaging module for communicating with a source of a print job;
an imaging process operably coupled to said imaging module and configured to generate image output as defined by said image data of said print job; and
a print job cancellation monitor configured to monitor said image data of said print job for at least one corrupt print job characteristic and further configured to when said at least one corrupt print job characteristic is detected, cancel a remainder of said print job.

19. The imaging device of claim 18, wherein said print job cancellation monitor is further configured to generate a print job cancellation status and said imaging device further comprises a status notification means to route said print job cancellation status to said source of said print job.

20. The imaging device of claim 18 wherein said print job cancellation monitor is further configured to generate a print job cancellation status and said imaging device further comprises a status notification means to post said print job cancellation status for access by an interested party.
